(19) United States
(12) Patent Application Publication
(10) Pub. No.: US 2026/0265967 A1
(43) Pub. Date: Sep. 10, 2026

(54) BRAIDER CARRIER FOR FLAT PREPREG COMPOSITE TAPE

(71) Applicant: MISSOURI STATE UNIVERSITY, Springfield, MO (US)

(72) Inventor: JONATHAN G. KEETH, SPRINGFIELD, MO (US)

(21) Appl. No.: 19/356,978

(22) Filed: Oct. 13, 2025

Related U.S. Application Data
(60) Provisional application No. 63/706,384, filed on Oct. 11, 2024.

(51) Int. Cl. D04C 3/14; D04C 3/48

(52) U.S. Cl. CPC D04C 3/14; D04C 3/48

(57) ABSTRACT

A braider carrier is provided. The carrier is capable of handling flat prepreg composite tape of varying widths. The carrier has a scalable design that allows use on any size maypole braiding machine. The carrier's spindle design allows for simple loading and material exchanges using commercially available spools. The carrier's clutch and tensioning mechanism can produce material tensions and payouts at stepped intervals, such as in the 3-20 lbs range. The carrier includes a mechanism for retaining spent poly liner that has minimal parasitic losses.

### CROSS-REFERENCE TO RELATED APPLICATIONS

This application claims priority pursuant to 35 U.S.C. 119(e) to U.S. Provisional Patent Application Ser. No. 63/706,384, filed Oct. 11, 2024, the entire disclosure of which is incorporated herein by reference.

### GOVERNMENT RIGHTS

This invention was made with government support under SC 72089-6771-46 and FA8650-21-2-5261 awarded by the Airforce/Physical Sciences Inc. and USAF/AFRL, respectively. The government may have certain rights in the invention.

### FIELD OF THE INVENTION

The present invention relates generally to braiding technology. More specifically, the present invention is concerned with a braider carrier facilitating automated layup of pre-impregnated composite tape of various widths.

### BACKGROUND

Composite bodies of revolution are widely used in various industries due to their high strength-to-weight ratio, corrosion resistance, and durability. They are typically formed by hand layup, automated fiber placement, or filament winding. The composite materials are often pre-impregnated with a resin that cures to form a solid, rigid structure.

Despite the advantages of composite bodies of revolution, their manufacture presents several challenges. One of these challenges is ensuring a uniform distribution of the resin throughout the part. If the resin is not evenly distributed it can lead to weak spots in the part, reducing its overall strength and durability. Accordingly, it would be beneficial to have a system for and a method of manufacturing a composite body of revolution that promotes the even distribution of resin throughout the composite part.

A common weak point in composite bodies of revolution are the seams. In most traditional production methods, seams are an unavoidable side effect of piecing together patterned parts one layer at a time. Accordingly, it would be beneficial to have a system for or method of eliminating or otherwise reducing the number of seams in a composite body of revolution.

Hand layup of composite parts is a manufacturing process that has been widely used in various industries for its versatility and cost-effectiveness. The hand layup process is not particularly suitable for the production of composite bodies of revolution due to the complex geometry of these structures. Even with various methods of assisting the hand layup of composite bodies of revolution, the quality of the finished product is highly dependent on the skill and experience of the technician. Accordingly, it would be beneficial to have a system for and a method of reducing or eliminating the human element from the quality equation.

Maypole braiding machines utilize a plurality of bobbins arranged around a central axis, each of which moves in a predetermined pattern to create the braided structure. In this way, maypole braiding machines mimic the traditional maypole dance, where dancers weave in and out around a central pole intertwining their ribbons as they go. While maypole braiding machines are presumably satisfactory for their intended purposes, traditional maypole machines are not capable of handling wide composite pre-preg tape. Accordingly, it would be beneficial to combine a traditional maypole braider bed with a carrier system capable of handling wide composite pre-preg tape.

### SUMMARY

The present invention comprises improved systems for and methods of forming composite bodies of revolution. In some embodiments, the systems and methods of the present invention facilitate even distribution of resin, thereby increasing the overall strength and durability of the cylinder. In some embodiments, the systems and methods of the present invention facilitate the production of composite parts that lack material seams. In some embodiments, the systems and methods of the present invention reduce or eliminate the human element from the quality equation. In some embodiments, the systems and methods of the present invention give a traditional maypole braiding machine the ability to use wide pre-preg composite tape to form high-quality composite bodies of revolution.

The present invention facilitates the braiding of large diameter composite parts for a variety of applications, such as applications for the aerospace industry. Some embodiments of the present invention facilitate layup of composite bodies for advanced weaponry, such as hypersonic missiles or the like. In some embodiments, the present invention allows for lay down rates that far exceed traditional hand lay-up processes. In some embodiments, the present invention utilizes high material capacity and/or large width tapes to improve lay down rates. In some such embodiments, the combination of high material capacity and large width tapes increases production and reduces cost.

In some embodiments, the present invention includes one or more feature to facilitate assembly, installation, adjustment, utilization, repair, replacement, and/or removal of various features of the present invention. In some such embodiments, the present invention utilizes a clutch housing that is configured to facilitate quick and reliable adjustment of an associated clutch mechanism. In some embodiments, the present invention is configured to facilitate preloading springs for a single carrier, thereby facilitating restarting braiding for the entire system following reloading of a single carrier or following a single failure, such as a toe break, or otherwise facilitating adjustment or repair of the system during operation. In some embodiments, the present invention includes an adjustable feature, such as an adjustable plate clutch, to facilitate adjustment of the take-up tension, such as by increasing or decreasing associated friction. In some embodiments, the present invention utilizes one or more features to improve tape movement, such as by aligning the tape with a guide mechanism and/or by preventing the tape from flipping prior to going through the guide mechanism. In some embodiments, a curved aperture is utilized to maximize tape movement while minimizing tape flipping.

The foregoing and other objects are intended to be illustrative of the invention and are not meant in a limiting sense. Many possible embodiments of the invention may be made and will be readily evident upon a study of the following specification and accompanying drawings comprising a part thereof. Various features and sub combinations of the invention may be employed without reference to other features and sub combinations. Other objects and advantages of this invention will become apparent from the following description taken in connection with the accompanying drawings, wherein is set forth by way of illustration and example, an embodiment of this invention and various features thereof.

### BRIEF DESCRIPTION OF THE DRAWINGS

Embodiments of the present invention are described in detail below with reference to the attached drawing figures, wherein:

FIG. 1 is an image showing a braider carrier of the present invention.

FIG. 2 is an image showing a payout mechanism of the braider carrier of FIG. 1.

FIG. 3 is an image showing a take-up mechanism of the braider carrier of FIG. 1.

FIG. 4 is an image showing a recoil mechanism of the braider carrier of FIG. 1.

FIG. 5 is an image showing the braider carrier of FIG. 1 from a different angle.

FIG. 6 is an image of two braider carriers of different sizes, each shown with a material supply spool and a take-up spool engaged thereto, each having a curved guide mechanism, and the larger braider carrier having a clutch housing.

FIGS. 7A and 7B are images of the clutch housing of FIG. 6.

FIGS. 7C and 7D are images of a main body of a clutch housing.

FIG. 7E is an image of a lid assembly of a clutch housing.

FIG. 7F is an image of a lid body of the lid assembly of FIG. 7E.

FIG. 8A is an image of a braider carrier having a guide assembly and additional guide elements, the braider carrier shown with a material supply spool and a take-up spool engaged thereto and primary and secondary material engaged therewith.

FIG. 8B is an additional image of the braider carrier of FIG. 8A.

FIG. 8C is an image of the guide assembly of the braider carrier of FIG. 8A.

FIG. 8D is an image showing a variety of guide assemblies and guide mechanisms associated with different embodiments of the present invention.

FIG. 9 is an image of a guide mechanism of certain embodiments of the present invention, the guide mechanism defining a curved primary aperture.

FIG. 10A is an image of a spindle and shoulder of a take-up mechanism of the larger braider carrier of FIG. 6.

FIG. 10B is an image of an adjustable friction clutch associated with the take-up mechanism of FIG. 10A.

FIG. 11A is an image of components of a take-up mechanism of the smaller braider carrier of FIG. 6.

FIG. 11B is a cross-sectional view of the take-up mechanism of FIG. 11A.

The drawing figures do not limit the present invention to the specific embodiments disclosed and described herein. The drawings are not necessarily to scale, emphasis instead being placed upon illustrating the principles of the invention.

### DETAILED DESCRIPTION

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

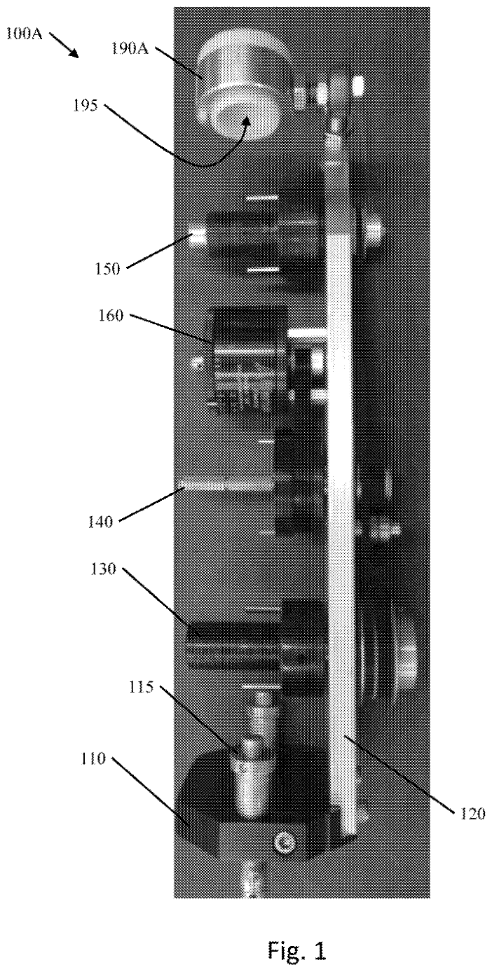

Referring to FIGS. 1, 6, and 8B, some embodiments of the present invention is a flat tape braider carrier (“braider carrier” or “carrier”) 100A, 100B, 100C, and 100D (alternatively, “100”) that is configured to be used with a maypole braiding machine in lieu of a traditional bobbin. In some embodiments, the braider carrier 100 includes a base member 110 and a stanchion 120 extending therefrom. In some such embodiments, at least one engagement member 115 engages with the base member 110 and a maypole machine for engaging the braider carrier 100 with the maypole machine. The stanchion 120 includes opposed proximal and distal ends, with the proximal end being coupled to the base member 110 and the distal end being displaced therefrom. The stanchion 120 provides a support structure for various components of the braider carrier 100, thereby facilitating proper relative spacing of the various components of the braider carrier 100. In the embodiment shown, the various components of the braider carrier 100 include a payout mechanism 130 for receiving a material supply spool (a “supply spool”) 30, a recoil mechanism 140 functionally coupled with the payout mechanism 130, a take-up mechanism 150 functionally coupled with the payout mechanism 130 and being configured to receive a take-up spool 50, and a guide mechanism 190A and 190B (alternatively, “190”) positioned at or near the distal end of the stanchion 120.

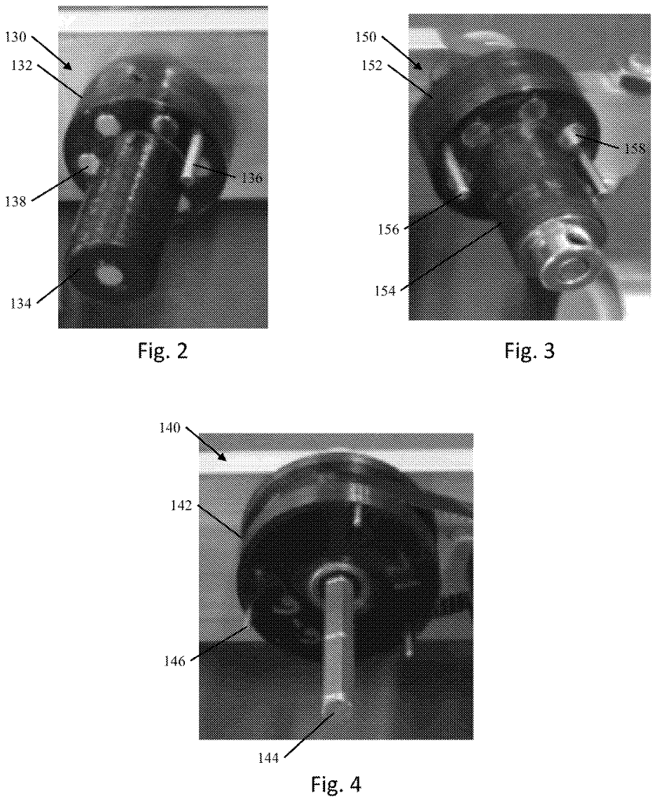

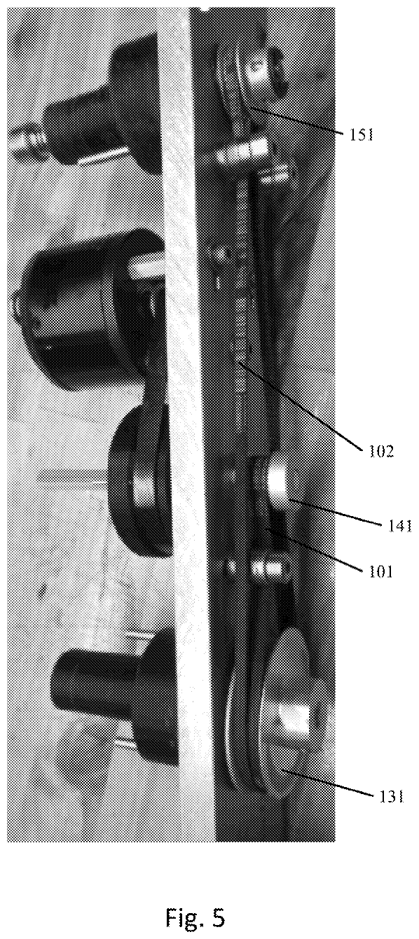

Referring to FIG. 2, the payout mechanism 130 includes a shoulder 132 and a spindle 134 extending coaxially from the shoulder 132. At least one engagement pin 136 also extends from the shoulder 132, the at least one engagement pin being parallel with, but displaced radially from, the spindle 134. In this way, the payout mechanism 130 is configured for receiving and engaging with a supply spool 30, such as a commercially available cardboard spool.

In some embodiments, the payout mechanism 130 also includes a retention mechanism 138 for maintaining engagement of the supply spool 30 with the payout mechanism 130. In the embodiment shown, the retention mechanism 138 is a plurality of magnets embedded in the shoulder 132 of the payout mechanism 130, each magnet being configured to magnetically bias a steel plugged core of the supply spool 30 towards the shoulder 132 of the payout mechanism 130, thereby inhibiting the supply spool from disengaging from the payout mechanism 130.

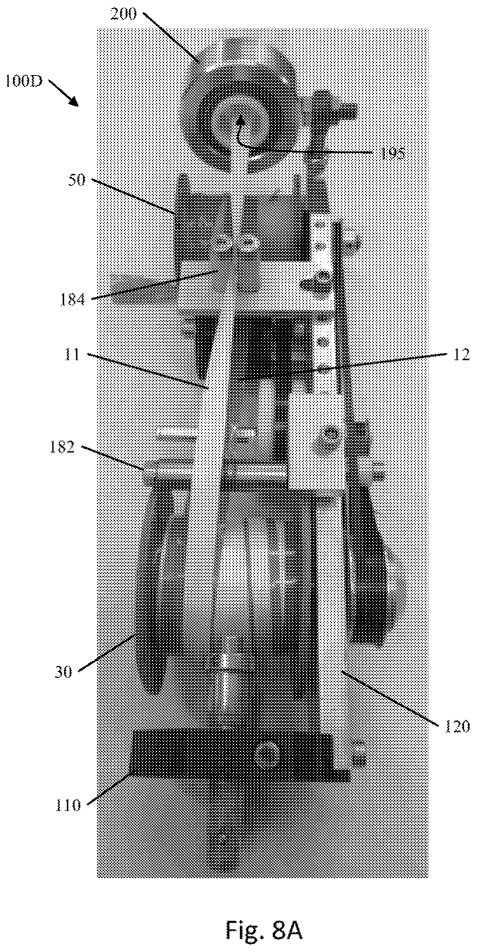

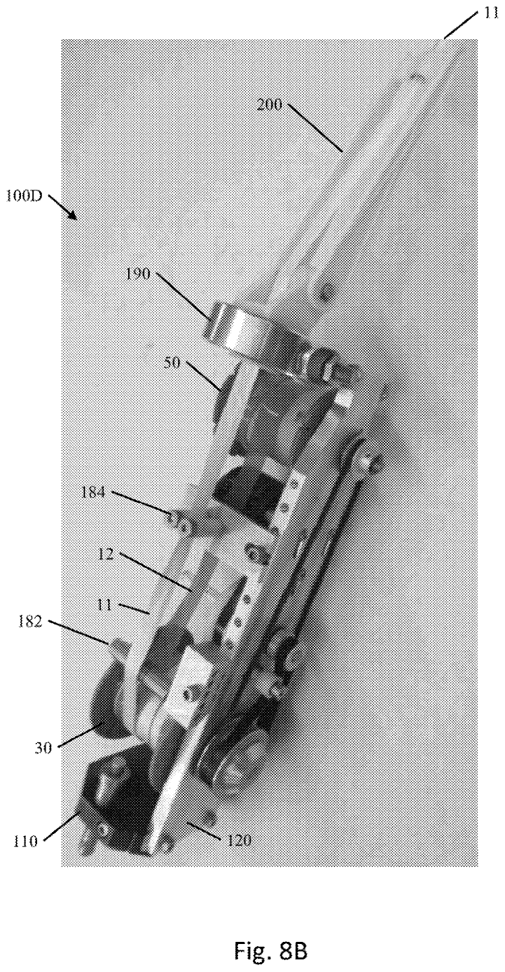

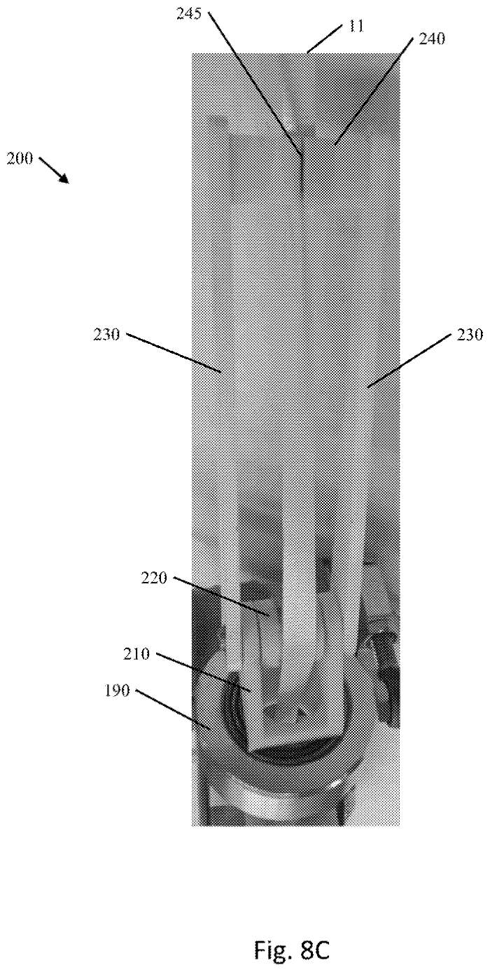

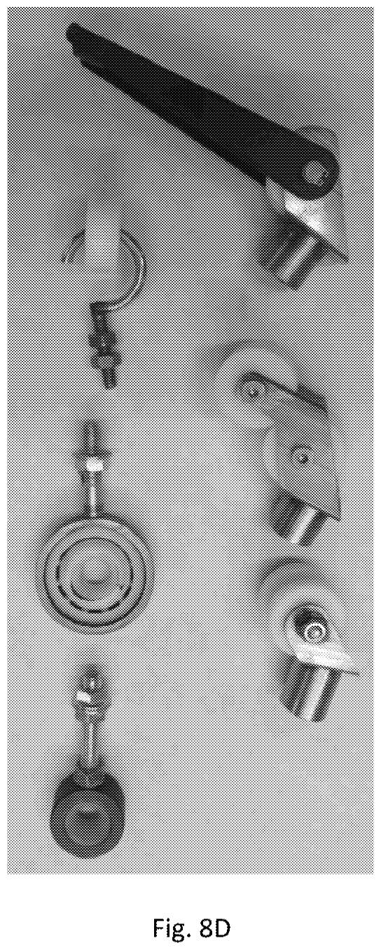

Referring to FIG. 8B, the supply spool 30 holds several wrapped layers of a primary material 110, such as pre-impregnated (pre-preg) slit composite materials or the like. In some embodiments, a secondary material 12, such as a poly liner or the like, is positioned between each wrapped layer of the primary material 11, thereby preventing or otherwise inhibiting subsequent layers of traverse wound primary material 11 from adhering to the underlying layers. In use, the primary material 11 is pulled through a guide mechanism 190 and the secondary material is wrapped onto a take-up spool 50 associated with the take-up mechanism 150. In some such embodiments, the secondary material 12 is coupled to the take-up spool 50, such as by being attached at defined locking points laser cut into a flange of the take-up spool 50.

Referring to FIG. 3, the take-up mechanism 150 includes a shoulder 152 and a spindle 154 extending coaxially from the shoulder 152. At least one engagement pin 156 also extends from the shoulder 152, the at least one engagement pin being parallel with, but displaced radially from, the spindle 154. In this way, the take-up mechanism 150 is configured for receiving and engaging with the take-up spool. In some embodiments, the take-up mechanism 150 also includes a retention mechanism 158 for inhibiting the take-up spool from disengaging from the take-up mechanism 150.

The take-up mechanism 150 is functionally coupled with the payout mechanism 130 such that the secondary material 12 is wrapped onto the take-up spool 50 while the primary material 11 is pulled from the supply spool 30, such as when the primary material 11 is pulled through the guide mechanism 190 to a mandrel for braiding. In some embodiments, the take-up mechanism includes a one-way bearing that allows a take-up axle 153 to be driven in one direction only, the take-up direction. In some such embodiments, the one-way bearing is associated with a take-up gear 151 of the take-up mechanism 150. In some embodiments, the functional coupling between the supply 30 and take-up 50 spools allows the take-up spool 50 to be overdriven, making up for diametric differences between the primary 11 and secondary 12 materials on their respective spools. In some embodiments, the take-up mechanism 150 includes a second one-way bearing to prevent or otherwise inhibit backward rotation of the take-up spool axle during the recoil of primary 11 and secondary 12 material.

The functional coupling of the payout 130 and take-up 150 mechanisms facilitates pulling secondary material 12 from the take-up spool 50 when the recoil mechanism 140 causes a portion of the primary material 11 to be recoiled back onto the supply spool 30. In some embodiments, a slip clutch associated with the take-up spindle hinders the take-up spool from rotating backwards during recoil, thereby preventing unnecessary backwards rotation and paying back only the necessary amount of secondary material 12 to the supply spool. In some such embodiments, the slip clutch is adjustable so that associated tension in the secondary material 12 can be controlled, thereby reducing the risk of inadvertent failure of the secondary material 12 while also avoiding unnecessary unwinding of the secondary material 12 during (or after) recoil. In some embodiments, the take-up mechanism 150 includes a one-way bearing to prevent or otherwise inhibit reverse rotation of the take-up spool axle during material recoil, facilitating the engagement of the slip clutch.

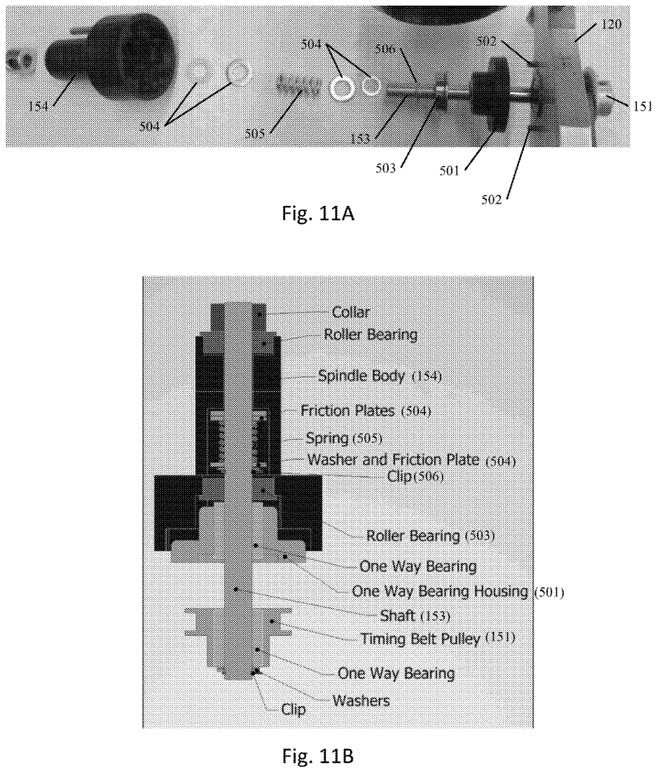

Referring to FIGS. 10A and 10B, the take-up mechanism of some embodiments of the present invention is specifically designed to engage with the friction clutch. In some such embodiments, a distal end of the spindle 154 of the take-up mechanism 150 defines a keyed recessed area 155 that is configured to engage with components of a slip clutch, thereby forming an integrated slip clutch. Referring to FIGS. 11A and 11B, other embodiments utilize a friction clutch having a biasing member 505 and opposed friction members 504, a proximal friction member engaging with a clip member 506 and a distal friction member engaging with an internal surface of the spindle 154. In some embodiments, a magnetic clutch may be used as the slip clutch.

Referring to FIG. 4, the recoil mechanism 140 includes a main body 142 and an axle 144 extending coaxially through the main body 142. At least one engagement mechanism 146 also extends from the main body 142, at least one engagement mechanism 146 being parallel with, but displaced radially from, the axle 144. In this way, the main body 142 is configured for receiving and engaging with a biasing member (a “spring module”). In some embodiments, the axle 144 of the recoil mechanism 140 also includes a retention mechanism for inhibiting the decoupling of one or more spring modules from the main body 142. In some embodiments, the main body 142 includes a biasing member such that the main body 142 itself is a spring module.

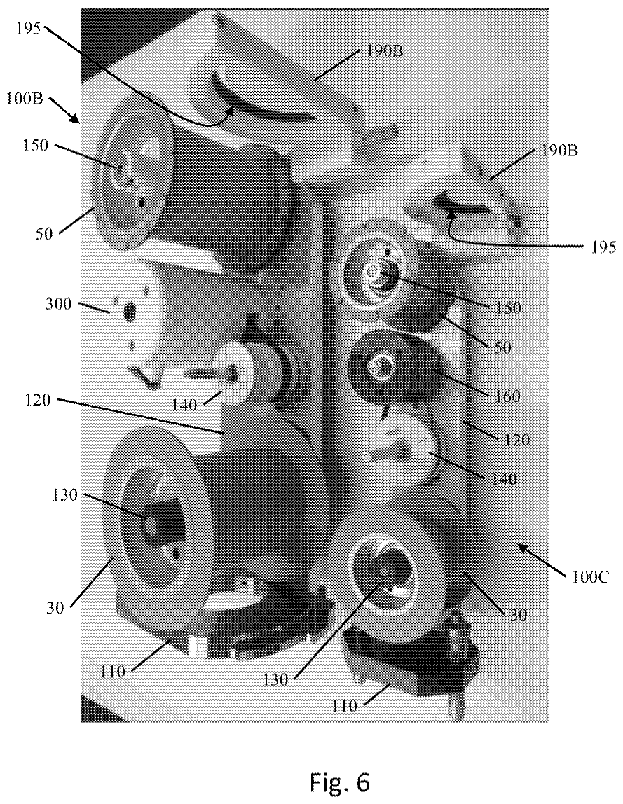

In some embodiments, the main body 142 of the recoil mechanism 140 includes and/or is functionally coupled with a clutch mechanism 160, such as the magnetic clutch shown in FIG. 1. Referring to FIG. 6, some embodiments of the present invention include a clutch housing 300 associated with the clutch mechanism 160. In some embodiments, the clutch mechanism 160 is configured to inhibit rotation of the main body 142 of the recoil mechanism 140, allowing axle 144 to impart potential energy to one or more spring module of the recoil mechanism 140. In some embodiments, the magnetic clutch 160 allows the payout of the primary material to the work mandrel to continue after all spring modules reach a threshold value, such as being fully wound.

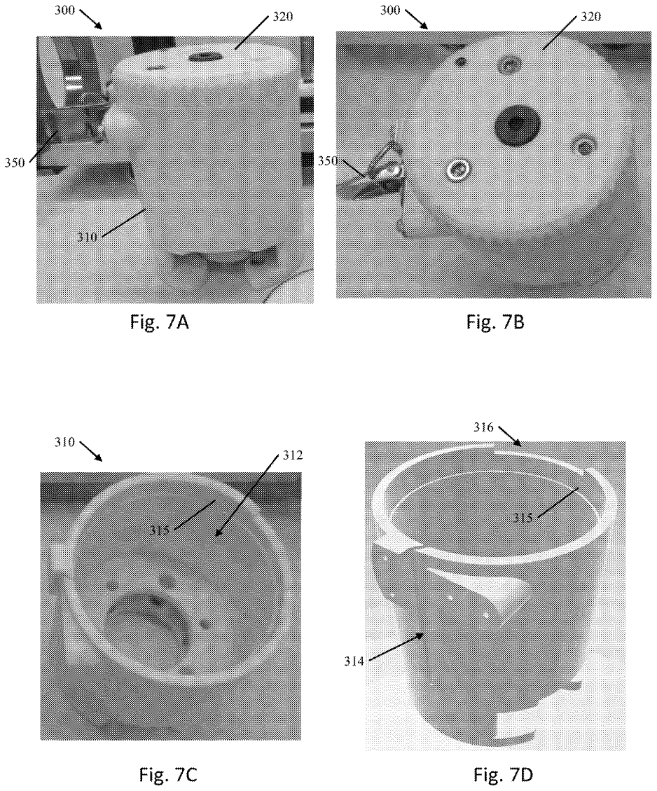

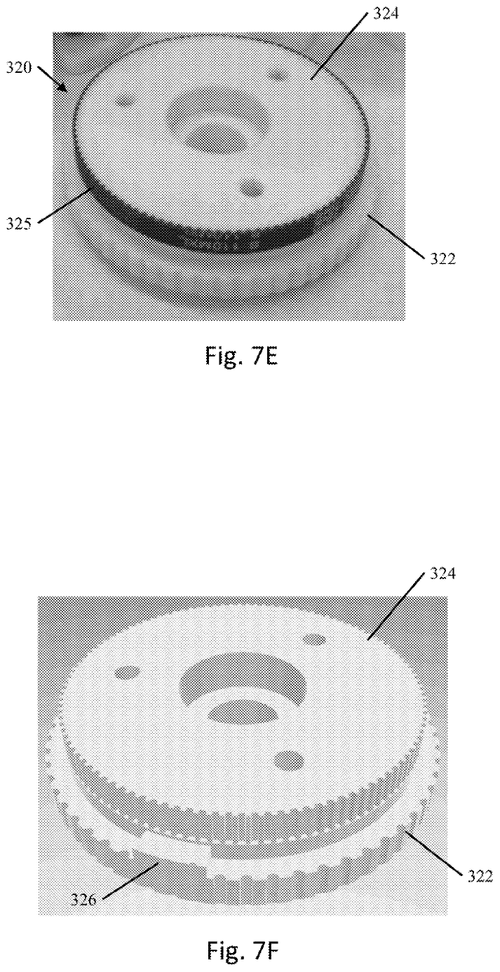

Referring to FIGS. 7A to 7F, some embodiments of a clutch housing 300 of the present invention include a main body 310 and a lid 320 engaged thereto, thereby enclosing a clutch mechanism 160 within an interior area 312 defined by the main body 310. In some embodiments, the lid 320 is secured to the clutch mechanism 160 such that the lid 320 provides a mechanical advantage for adjusting break-away tension for the clutch mechanism 160. In some such embodiments, a top portion 322 of the lid 320 is configured to facilitate manual adjustment of the break-away tension.

For the clutch housing 300 embodiment shown in FIGS. 7A to 7F, a bottom portion 324 of the lid assembly 320 is received by a top opening of the main body 310 when the clutch housing 300 is in a closed configuration. When in the closed configuration, the clutch housing 300 is moveable between an adjustable configuration, to facilitate adjustment of break-away tension for the clutch mechanism 160, and a secured configuration, to retain break-away tension of the clutch mechanism 160. In some embodiments, when the clutch housing 300 is in the adjustable configuration, an inner engagement surface 315 defined by an upper portion of the main body 310 is spaced apart from, or is slidably engaged with, an outer engagement surface 325 defined by the bottom portion 324 of the lid 320. In some such embodiments, when the clutch housing 300 is in the secured configuration, the main body 310 applies pressure to the bottom portion of the lid 320 such that friction between the inner 315 and outer 325 engagement surfaces prevents or otherwise inhibits rotation of the lid 320 relative to the main body 310.

In some embodiments, the clutch housing 300 includes a clamping hasp 350 having first and second portions secured to opposed sides of a gap 314 defined by the main body 310 of the clutch housing 300. The clamping hasp 350 moves between clamped and released configurations, thereby moving the clutch housing 300 between its secured and adjustable configurations, respectively. In some embodiments, the outer engagement surface 325 is defined by an outer surface of a compression band secured to the bottom portion 324 of the lid 320. In some such embodiments, the compression band is a timing belt and the bottom portion 324 of the lid 320 defines a plurality of teeth engaged with the compression band.

In some embodiments, corresponding features of the main body 310 and lid 320 limit selective adjustment of break-away tension for the clutch mechanism 160. In some such embodiments, a positioning tab 326 of the lid 320 extends into a positioning window 316 defined by the main body 310, with the positioning window 316 being winder than the positioning tab 326. In some embodiments, the main body 310 and/or lid 320 of the clutch housing 300 includes indicia to facilitate identification of a clutch mechanism 160 setting associated with a relative position of the lid 320 with the main body 310. In some such embodiments, a plurality of indicia facilitate identification of a plurality of optional clutch mechanism 160 settings. In some embodiments, the housing is configured to facilitate a minimum tension setting associated with maintaining system integrity.

In some embodiments, the braider carrier 100 is configured to facilitate preloading the recoil mechanism 140 (such as by preloading one or more springs associated with the recoil mechanism) independent of material payout. In some embodiments, an axle 144 of the recoil mechanism 140 is configured for selective manual or other engagement, thereby facilitating introduction of mechanical energy for the generation of potential energy. In some such embodiments, the clutch mechanism is configured to facilitate such generation of potential energy. In other embodiments, an axle of the clutch mechanism is configured for selective manual or other engagement, thereby facilitating introduction of mechanical energy for the generation of potential energy within the recoil mechanism 140.

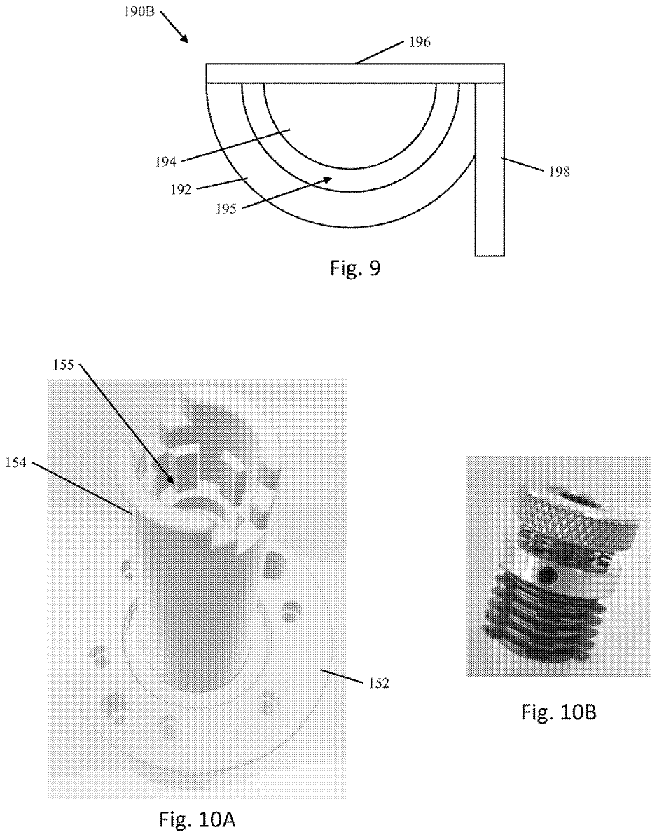

Referring to FIGS. 1 and 6, some guide mechanism 190 embodiments of the present invention define a primary aperture 195 that is sized, shaped, and positioned to facilitate payout of primary material 11 to a work mandrel. Referring to FIG. 1, some primary apertures 195 define a circular cross section. In some such embodiments, the guide mechanism 190 is an eyelet or the like. Referring to FIG. 6, some primary apertures 195 define a curved cross section. Referring to FIG. 9, some such guide mechanism 190B embodiments comprise an outer body 192 spaced apart from a corresponding inner body 194 with the primary aperture 195 positioned therebetween. In some embodiments, each of the outer 192 and inner 194 bodies are coupled to a cap member 196 extending from a support beam 198. In some such embodiments, the support beam 198 is coupled to the stanchion 120, thereby positioning the primary aperture 195 of the guide mechanism 190B relative to the payout mechanism 130 of the braider carrier 100.

Some embodiments of the present invention include a method of forming a composite structure using braider carriers of the present invention with a braiding machine, such as, but not limited to, a maypole braiding machine. While the primary material is being braided, the recoil 140, take-up 150, and clutch mechanisms 160 control the payout, take-up, and recoil of the primary and secondary materials. In some embodiments, each spring module of the recoil mechanism 140 includes a clock spring that is wound by a primary coupling mechanism 101 that functionally couples the payout mechanism 130 with the recoil mechanism axle 144. In some embodiments, the primary coupling mechanism 101 is a timing belt that runs between the payout mechanism 130 and the recoil mechanism 140, such as by way of a payout gear 131 and a recoil gear 141. The gearing of the coupling mechanism can be adjusted to accommodate the recoil needs of the particular braiding machine and/or the particular braiding action.

In some embodiments, each spring module is keyed to the axle 144 of the recoil mechanism 140, thereby facilitating the transfer of mechanical energy by the axle 144 into potential energy within the spring module. In some such embodiment, the cross section of the axle 144 is a hexagon shape and each spring module defines a hexagon aperture for receiving and engaging with the axle 144. In the embodiment shown in FIG. 1, a spring, or spring set, is wound by the hex axle, which can hold up to three spring modules. It will be appreciated that different combinations of spring modules will result in multiple possible material tensions.

During the braiding process, the recoil mechanism 140 moves in and out of first and second configurations. While in the first configuration, the act of pulling on the material (paying out composite tape to a part or a carrier moving outwards in its sinusoidal path) increases the potential energy in each spring module until a threshold amount of potential energy, such as a maximum amount of potential energy, is obtained. In some such embodiments, the clutch mechanism 160 prevents or otherwise inhibits the spring module(s) of the recoil mechanism 140 from rotating with the axle 144 of the recoil mechanism 140 while each spring module is receiving potential energy from material payout. In some such embodiments, the recoil mechanism 140 moves out of the first configuration when it can receive no more potential energy. In some such embodiments, moving out of the first configuration includes releasing the clutch mechanism 160, thereby allowing each spring module of the recoil mechanism 140 to rotate with the axle 144 of the recoil mechanism 140 and the axle of clutch mechanism 160. In some such embodiments, material payout tension is governed by the setting of clutch mechanism 160.

In some embodiments, setting the clutch mechanism 160 comprises moving a clutch housing 300 from a secured configuration to an adjustable configuration, rotating a lid 320 of the clutch housing 300 relative to a main body 310 of the clutch housing 300, and moving the clutch housing 300 from the adjustable configuration back to the secured configuration. In some such embodiments, when the clutch housing 300 is in its adjustable configuration, movement of the lid 320 relative to the main body 310 is limited by corresponding features of the lid 320 and main body 310, such as by a positioning tab 326 of the lid 320 extending into a positioning window 316 defined by the main body 310. In some embodiments, when the clutch housing 300 is in its secured configuration, movement of the lid 320 relative to the main body 310 is prevented or otherwise inhibited by friction between an inner engagement surface 315 of the main body 310 and an outer engagement surface 325 of a bottom portion of the lid 320. In some embodiments, movement of the clutch housing 300 between its adjustable and secured configurations is accomplished by moving a clamping hasp 350 between respective released and clamped configurations, thereby opening and closing, respectively, a gap defined by the main body 310 of the clutch housing 300.

When in the second configuration, the recoil mechanism 140 exerts a reverse biasing force on the payout mechanism. When a carrier is moving radially inwards during its sinusoidal path, excess material may need to be recoiled. The reverse biasing force from the recoil mechanism 140 causes a portion of the primary material and secondary material to be pulled back onto the supply spool, thereby preventing or otherwise inhibiting material in the braid cone from becoming loose.

In some embodiments, the take-up mechanism 150 is driven (or overdriven, as the case may be) by a secondary coupling mechanism 102 that functionally couples the take-up mechanism 150 with the payout mechanism 130, such as by way of a take-up gear 151 and a payout gear 131. To accommodate for the differences in loaded vs. unloaded spool diameters, some embodiments of the take-up mechanism are overdriven to ensure that slack does not form between the supply spool and the take-up spool. In some such embodiments, this overdrive mechanism is achieved via belt (or other) gearing between the payout and take-up mechanisms. In some embodiments, the gearing difference is mediated by a friction clutch of the take-up mechanism, thereby allowing a take-up axle 153 of the take-up mechanism 150 to be overdriven while rotation of the take-up spindle 154 is limited to what is necessary to take up the secondary material, thereby accommodating for the difference between a full and empty supply spool. In the embodiment shown in FIGS. 11A and 11B, the friction clutch includes a biasing member 505 positioned between opposed friction members 504. Referring to FIGS. 10A and 10B, other embodiments utilize different styles of clutches.

The friction associated with the friction clutch is set to accommodate, during take-up of the secondary material without snapping the secondary material, the overdrive of the take-up axle 153 relative to the rotation of the take-up spindle 154. In some embodiments, the friction associated with the friction clutch is set to accommodate, without snapping the secondary material during recoil, rotation of the take-up spindle 154 relative to the rotation of the take-up axle 153. In some such embodiments, the friction clutch is set to accommodate a stationary take-up axle during recoil. In some embodiments, the friction clutch is adjustable to accommodate different materials, different spool sizes, different recoil tensions, different overdrive amounts, and the like. In some embodiments, the friction clutch also eliminates or otherwise reduces loose secondary material between the take-up spool and the supply spool.

In some embodiments, a take-up gear 151 is coupled to the take-up axle 154 via a first one-way needle bearing that allows the take-up gear 151 to drive rotation of the take-up axle 153 during take-up of the secondary material while also allowing the take-up gear 151 to rotate independent of the take-up axle 153 during recoil. In this way, the first one-way needle bearing allows the take-up axle 153 to remain stationary during recoil. In the embodiment shown in FIGS. 11A and 11B, a second one-way needle bearing is associated with an axle hub 501 that is coupled to the stanchion 120 by way of two pins 502, thereby preventing rotation of the axle hub 501 during recoil.

In some embodiments, a take-up bearing 503 coupled to the take-up axle 153 facilitates, during recoil, rotation of the take-up spindle 154 relative to the take-up axle 153. To eliminate or otherwise reduce loose secondary material between the take-up spool and the supply spool, the rotation of the take-up spool is mediated by the friction clutch and the composite tape is rewound onto the supply spool by a recoil force generated from the potential energy stored in the recoil mechanism 140. To engage the friction clutch for recoil of the secondary material, the second one-way needle bearing is used to keep the take-up axle 153 from spinning in reverse.

In some embodiments, the present invention includes preloading the recoil mechanism 140 independent of material payout, such as to facilitate reloading a single carrier and/or repairing a single point of failure. In some such embodiments, preloading the recoil mechanism 140 is accomplished through introduction of mechanical energy to an axle 144 of the recoil mechanism 140, thereby generating potential energy within the recoil mechanism 140. In other such embodiments, preloading the recoil mechanism 140 is accomplished through introduction of mechanical energy to the clutch mechanism.

In some embodiments, the present invention includes aligning primary material 11 with a primary aperture 195 of a guide mechanism 190. In some such embodiments, the method includes extending the primary material through adjacent lateral guides 184, thereby causing the primary material 11 to flip 90 degrees relative to primary material 11 positioned on the supply spool 30. In this way, lateral movement of the primary material 11 associated with the side to side wrapping of primary material 11 on the supply spool 30 is reduced or eliminated prior to the primary material 11 extending to the primary aperture 195 of the guide mechanism 190. In some such embodiments, an offset guide 182 is positioned between the supply spool 30 and the adjacent lateral guides 184, thereby facilitating alignment of the primary material 11 with the lateral guides.

In some embodiments, the braiding process includes pulling primary material 11 through a guide assembly 200 of the present invention. In some such embodiments, the guide assembly 200 extends from a guide mechanism 190 of the present invention, such as by coupling a guide bracket 210 with the guide mechanism 190. In some embodiments, the present invention includes engaging the primary material 11 with the guide assembly 200, such as by running the primary material 11 through the guide bracket 210, over a guide roller 220 coupled to the guide bracket 210, between guide arms 230 extending from the guide bracket 210, and/or through a guide bar 240 coupled to distal ends of the guide arms 230. In some embodiments, the present invention further includes moving the primary material 11 in and out of engagement with the guide bar 240, such as by slipping the primary material 11 through a slit 245 defined by the guide bar 240. When the primary material 11 is engaged with the guide bar 240 during a braiding process, lateral forces applied to the guide bar 240 by the primary material 11 causes the primary arms 260 to rotate relative to the guide bracket 210 and/or cause the guide bracket 210 to rotate relative to the guide mechanism 190.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall within the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

What is claimed is:

1. A braider carrier for use with a braiding machine for braiding a composite structure during a braiding process, the braider carrier comprising:
a payout mechanism for receiving a supply spool having primary and secondary materials wrapped thereon, the primary material being a composite material for forming the composite structure, and the secondary material being a separating layer for preventing or otherwise inhibiting layers of primary material wrapped on the supply spool from adhering to each other; and
a take-up mechanism functionally coupled with said payout mechanism,
wherein said payout mechanism is configured to facilitate, during payout portions of the braiding process, payout of the primary material, and
wherein said take-up mechanism is configured to facilitate:
take up of the secondary material during the payout portions of the braiding process; and
recoiling the secondary material during recoil portions of the braiding process.

2. The braider carrier of claim 1, further comprising:
a recoil mechanism functionally coupled with said payout mechanism,
wherein said recoil mechanism exerts a reverse biasing force on the payout mechanism, the reverse biasing force being associated with the recoil portions of the braiding process.

3. The braider carrier of claim 2, wherein said recoil mechanism comprises at least one biasing member that is configured to store potential energy, the stored potential energy being associated with the reverse biasing force.

4. The braider carrier of claim 3, wherein the functional coupling of said recoil mechanism with said payout mechanism facilitates conversion of payout mechanical energy to the stored potential energy, the payout mechanical energy being associated with the payout portions of the braiding process.

5. The braider carrier of claim 4, further comprising:
a clutch mechanism functionally coupled with said recoil mechanism,
wherein said clutch mechanism facilitates the conversion of the payout mechanical energy to the stored potential energy, and
wherein a break-away tension of said clutch mechanism is associated with a threshold value for the stored potential energy.

6. The braider carrier of claim 5, further comprising a clutch housing to facilitate adjustment of the break-away tension of said clutch mechanism, said clutch housing comprising:
a main body defining an interior area for receiving said clutch mechanism; and
a lid that is secured to said clutch mechanism and engaged with said main body, thereby enclosing said clutch mechanism within said interior area of said main body,
wherein a top portion of said lid defines a plurality of protrusions that are configured to facilitate manual adjustment of the break-away tension, and
wherein a bottom portion of said lid is received by a top opening of said main body.

7. The braider carrier of claim 6, wherein said clutch housing further comprises a clamping hasp having first and second portions secured to opposed sides of a gap defined by said main body, wherein said clamping hasp moves between clamped and released configurations, thereby moving said clutch hosing between secured and adjustable configurations, respectively.

8. The braider carrier of claim 7, wherein corresponding features of said main body and said lid limit selective adjustment of the break-away tension for said clutch mechanism, said corresponding features comprising a positioning window defined by said main body and a positioning tab extending below said top portion of said lid, said positioning window being wider than said positioning tab, thereby defining rotational limits of said lid relative to said main body.

9. The braider carrier of claim 8, further comprising:
a base member that is configured to selectively engage with the braiding machine;
a stanchion extending from said base member; and
a guide mechanism positioned near a distal end of said stanchion,
wherein said guide mechanism comprises an outer body spaced apart from a corresponding inner body such that the guide mechanism defines a curved primary aperture positioned therebetween.

10. The braider carrier of claim 1, further comprising:
a base member that is configured to selectively engage with the braiding machine;
a stanchion extending from said base member; and
a guide mechanism positioned near a distal end of said stanchion,
wherein said guide mechanism comprises an outer body spaced apart from a corresponding inner body such that the guide mechanism defines a curved primary aperture positioned therebetween.

11. A method of braiding a composite structure during a braiding process, the method comprising:
loading a supply spool onto a payout mechanism of a braider carrier, the supply spool having primary and secondary materials wrapped thereon, the primary material being a composite material for forming the composite structure, and the secondary material being a separating layer for preventing or otherwise inhibiting layers of primary material wrapped on the supply spool from adhering to each other;
utilizing the payout mechanism to payout the primary material during payout portions of the braiding process; and
utilizing a take-up mechanism of the braider carrier to:
take up of the secondary material during the payout portions of the braiding process; and
recoiling the secondary material during recoil portions of the braiding process,
wherein the take-up mechanism is functionally coupled with the payout mechanism.

12. The method of claim 11, further comprising:
utilizing a recoil mechanism of the braider carrier to exert a reverse biasing force on the payout mechanism,
wherein the reverse biasing force is associated with the recoil portions of the braiding process, and
wherein the recoil mechanism is functionally coupled with the payout mechanism.

13. The method of claim 12, further comprising utilizing at least one biasing member of the recoil mechanism to store potential energy, the stored potential energy being associated with the reverse biasing force.

14. The method of claim 13, utilizing the functional coupling of the recoil mechanism with the payout mechanism to convert payout mechanical energy to the stored potential energy, the payout mechanical energy being associated with the payout portions of the braiding process.

15. The method of claim 14, further comprising:
utilizing a clutch mechanism of the braider carrier to convert the payout mechanical energy to the stored potential energy,
wherein the clutch mechanism is functionally coupled with the recoil mechanism, and
wherein a break-away tension of the clutch mechanism is associated with a threshold value for the stored potential energy.

16. The method of claim 15, further comprising adjusting the break-away tension, wherein adjusting the break-away tension comprises:
moving a clutch housing of the braider carrier from a secured configuration to an adjustable configuration;
rotating a lid of the clutch housing relative to a main body of the clutch housing; and
moving the clutch housing from the adjustable configuration back to the secured configuration,
wherein the main body defines an interior area within which the clutch mechanism is positioned,
wherein the lid is secured to the clutch mechanism and engaged with the main body, thereby enclosing the clutch mechanism within the interior area of the main body,
wherein a top portion of the lid is configured to facilitate manual manipulation of the lid, and
wherein a bottom portion of the lid is received by a top opening of the main body.

17. The method of claim 16, wherein movement of the lid relative to the main body is limited by corresponding features of the lid and the main body, the corresponding features comprising a positioning window defined by the main body and a positioning tab extending below the top portion of the lid, wherein the positioning window is wider than the positioning tab, thereby defining rotational limits of the lid relative to the main body.

18. The method of claim 17, further comprising:
engaging the braider carrier with the braiding machine; and
extending the primary material through a curved primary aperture defined by a guide mechanism of the braider carrier,
wherein the guide mechanism comprises an outer body spaced apart from a corresponding inner body with the curved primary aperture positioned therebetween.

19. The method of claim 11, further comprising:
engaging the braider carrier with the braiding machine; and
extending the primary material through a curved primary aperture defined by a guide mechanism of the braider carrier,
wherein the guide mechanism comprises an outer body spaced apart from a corresponding inner body with the curved primary aperture positioned therebetween.

20. The method of claim 19, further comprising:
preloading a recoil mechanism of the braider carrier; and
utilizing the recoil mechanism to exert a reverse biasing force on the payout mechanism.
